(19) United States
(12) Patent Application Publication
(10) Pub. No.: US 2009/0217669 A1
(43) Pub. Date: Sep. 3, 2009

(54) Fuel nozzles

(76) Inventor: Kenneth J. Young, Derby (GB)

Correspondence Address: MANELLI DENISON & SELTER, 2000 M STREET NW SUITE 700, WASHINGTON, DC, 20036-3307, US

(21) Appl. No.: 12/289,117

(22) Filed: Oct. 21, 2008

Related U.S. Application Data
(63) Continuation-in-part of application No. 10/755,338, filed on Jan. 13, 2004, now abandoned.

(30) Foreign Application Priority Data
Feb. 5, 2003 (GB) 0302721.6

(51) Int. Cl. F02C 7/22

(52) U.S. Cl. 60/737

(57) ABSTRACT

In order to achieve better fuel distribution despite an oversized fuel injector nozzle relative to the impingement cross-section of an air flow directed towards that nozzle, an asymmetric distribution of fuel is provided. This asymmetric distribution is achieved by providing fuel distribution structures about the injector nozzle which present varying amounts of fuel to the air flow dependent upon the localised flow pressure in the air flow presented to the nozzle. Such asymmetric distribution of fuel is achieved by providing passages or jets of varying cross-section or distribution/spacing at different parts of the fuel injection nozzle dependent upon incident flow pressure. Thus, both parts of the injector nozzle directly impinged by the air flow generally present more fuel to that flow compared to depleted flow pressure zones of the air flow.

### FIELD OF THE INVENTION

The present invention relates to fuel nozzles and more particularly to fuel nozzles used with regard to gas turbine engines associated with aircraft.

### BACKGROUND OF THE INVENTION

There is an on-going objective to minimise noxious emissions from engines and noise in order to render such engines more environmentally acceptable. In such circumstances, it is necessary to ensure that the fuel/air mix within the engine is appropriately regulated to achieve the desired emissions objectives. Typically, as described in U.S. patent publication No. 2002/0134084 (Parker-Hannifin Corporation) fuel is presented to a swirling air flow in order to create an even distribution and therefore appropriate combustion within an engine.

In the injector described in US2002/0134084, the air flow from the engine compressor is entrained and passes through a diffuser such that its jet output cross-section is substantially the same width as or greater than the inlet for the fuel injector. In such circumstances, the fuel presented to the air flow passing through the fuel injector evenly washes that fuel presented within the fuel injector and a substantially even air/fuel mix is created for appropriate combustion. Typically, the fuel injector as depicted in the attached drawing marked “Prior Art” includes a number of swirl vanes to create air flow as well as fuel/air mixture turbulence for more appropriate combustion.

In combustor arrangements, as exemplified in U.S. Pat. No. 3,763,650, air is fed from an upstream compressor 12 through a diffuser into a large plenum chamber 13. In these arrangements the air is presented to the fuel injector at substantially even pressure.

More recently provision of wider cross-section air/fuel swirler arrangements have been provided in order to achieve leaner burning of the fuel/air combination. Unfortunately, such wider diameter fuel/air swirler arrangements results in a situation where these lean burn swirler arrangements are wider than the cross-section of the diffuser air flow jet. In such circumstances, portions of the air flow have a depleted or lower pressure compared to central direct impingement portions of the air flow such that there is differential air/fuel mixing across the fuel injector and this in turn may lead to varying combustion air to fuel ratio with possible detrimental effects upon emissions from the engine. These problems occur whether the fuel is presented to the air flow as a film or by direct fuel injection through jet apertures.

In accordance with the present invention there is provided a fuel injector arrangement for a gas turbine, the arrangement comprising an upstream diffuser and a downstream injector nozzle, the diffuser having a diverging passage for presenting a direct impingement air flow to the injector nozzle, the nozzle having a greater cross-section than the air flow directly impinging upon the nozzle in operation so that in operation the said nozzle has an air flow portion of higher pressure where there is direct impingement and air flow regions of lower pressure outside the portions of direct impingement, wherein the nozzle has a fuel distribution arrangement for presenting fuel to the air flow through the nozzle, the fuel being presented by fuel distribution structures in the nozzle, wherein the fuel distribution structures are asymmetrically distributed or sized to distribute in operation more fuel to said regions of higher pressure than to said regions of lower pressure.

The diverging passage may be annular to present an annular air flow.

Preferably the air flow impinges on the nozzle to provide a central flow portion of higher pressure and two regions of lower pressure flow portions the opposing edges of the central flow portion.

The fuel distribution structures may be arranged in an annular array, wherein the spacing between structures varies such that there is a shorter spacing between structures in the region of higher pressure and a longer spacing between structures in the regions of lower pressure

The fuel distribution structures may be arranged in an annular array, wherein the size of the structures varies such that there are larger structures in the region of higher pressure and a smaller structure in the regions of lower pressure. The fuel distribution structures may be grooves, passageways or apertures. Preferably the fuel distribution structure is angled relative to the direction of air flow.

### BRIEF DESCRIPTION OF THE DRAWINGS

Embodiments of the present invention will now be described by way of example only with reference to the accompanying drawings in which:

FIG. 1 is a schematic cross-section of a combustion chamber with a fuel injection nozzle in accordance with the present invention;

FIG. 2 is a schematic cross-section of a fuel injection nozzle in accordance with a first embodiment of the present invention;

FIG. 3 is a schematic cross-section of a fuel injection nozzle in accordance with a second embodiment of the present invention;

FIG. 4 is a schematic cross-section of a fuel combustion arrangement in accordance with an alternative construction;

FIG. 5 is a schematic front perspective of a first fuel distribution structure in accordance with the present invention;

FIG. 6 is a schematic cross-section of a second fuel distribution structure in accordance with the present invention; and

FIG. 7 is a schematic cross-section of a prior art combustion chamber with a fuel injection nozzle.

### DETAILED DESCRIPTION OF THE INVENTION

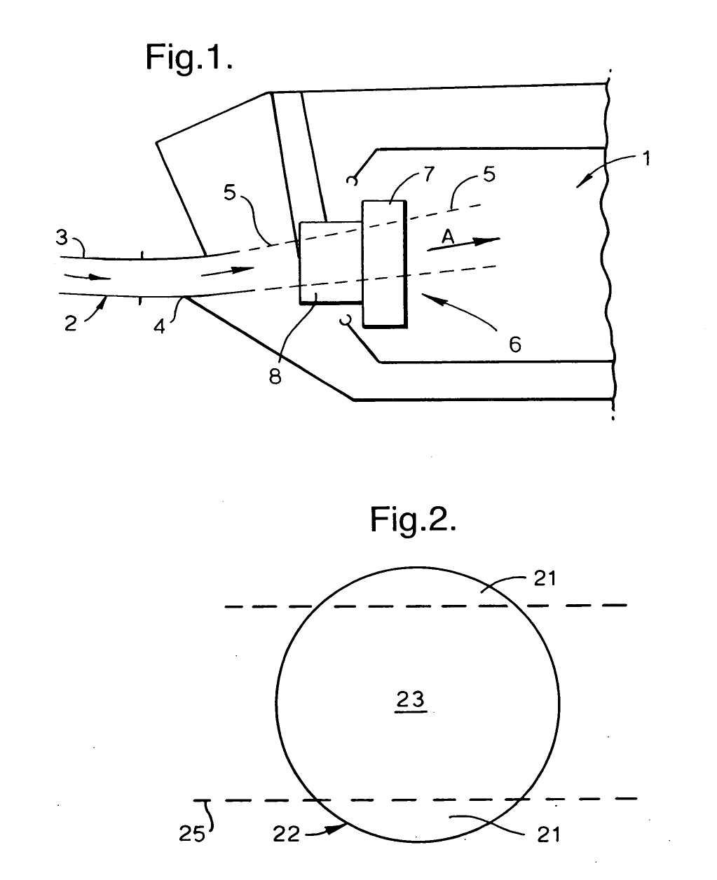

FIG. 1 schematically illustrates a combustion chamber 1 of an engine. The combustion chamber 1 is coupled to air coming from an upstream compressor via an air flow conduit 2 which comprises a passage 3 which leads to a diffuser 4 which in turn presents an air flow 5 to a fuel injection nozzle 6 in the direction of arrowhead A. An injection nozzle is substantially cylindrical with substantially circular upstream and downstream faces. The combustor is annular in form with a plurality of injection nozzles 6 arranged at uniform circumferential spacing around the annulus. The diffuser 4, which is a diverging channel, is also annular such that the air flow 5 takes the form of an annular ring of air flow in the direction of arrowhead A. This annular ring of air flow impinges upon the nozzle 6 whereby the swirl vanes 7 create air flow vorticity and turbulence to allow intermingling with fuel delivered in an injector portion 8 of the nozzle 6. It will be appreciated that it is the turbulent mixing of the air flow and fuel which creates the appropriate distribution for combustion within the chamber 1. Because the air is travelling at a relatively high velocity there is little diffusion of the direct impingement flow that is wider than an axially rearward extrapolation of the channel walls defining the annular duct.

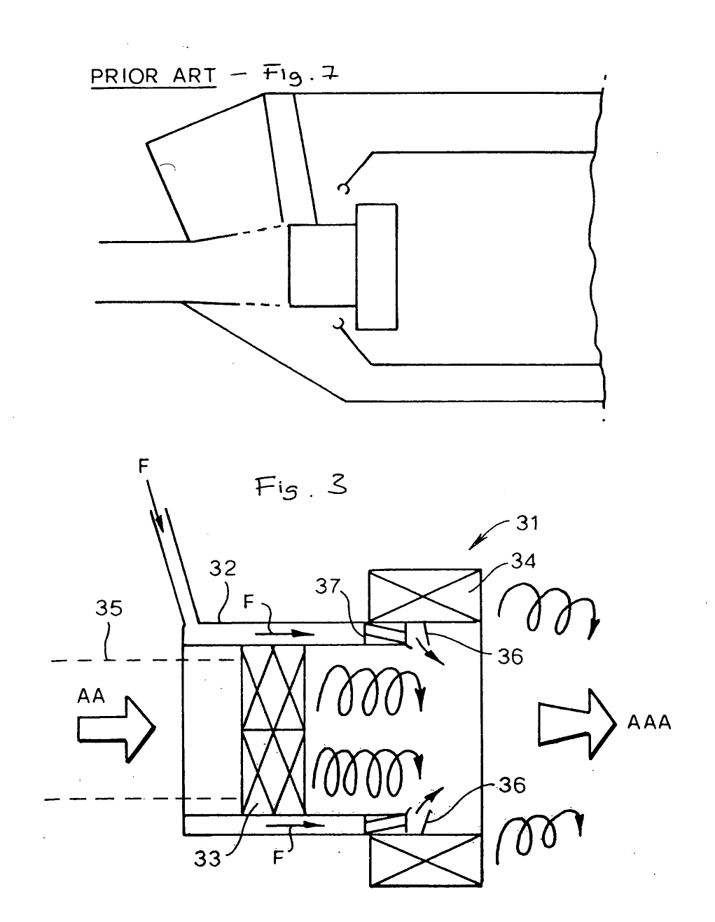

It will be noted that for large fuel injector nozzles the cross-sectional area of the direct air flow 5 presented to the injectors does not extend over the whole face of the injector. With the cross-sectional width of the flow 5 less than the incident cross-section of the fuel nozzle 6 it will be appreciated that as shown schematically in FIG. 2 portions 21 of a fuel nozzle incident profile 22 are out of direct impingement with the air flow 25 presented to the fuel nozzle 21. The pressure of air in the plenum chamber upstream of the injector is less than the pressure of the air in the flow 5 coming directly from the diffuser. Thus, these portions 21 have a depleted and lower air flow pressure compared to a direct impingement portion 23. Thus, when fuel is presented to the air flow 25 through the nozzle 22 the localised pressure differential between the depletion portions 21 and the direct impingement portion 23 is such that there is variable fuel pick-up and dispersion. Such variation in the fuel pick-up and dispersion will be reflected in the eventual combustion stage within the chamber 1 (FIG. 1).

In accordance with the present invention a fuel distribution structure is provided within a fuel injection nozzle in order to provide asymmetric fuel distribution and therefore fuel pick-up to the air flow between the localised portions 21, 23. In short the fuel distribution structure normally provides for less fuel presentation in the depletion portions 21 in comparison with the direct impingement portion 23. Thus a more consistent fuel distribution and mix is provided as a result of the action of the fuel distribution structure provided in accordance with the present invention. A more even distribution of fuel within the air fuel mixture will provide more consistent combustion and therefore reduced emissions. Normally, there will be one fuel distribution structure integrally formed in the injection nozzle however, where possible or desirable for easier assembly, fuel distribution may be achieved by a number of fuel distribution structures configured in accordance with the present invention to provide an assembly or arrangement necessary for desired fuel distribution. The fuel distribution structures may be channels or slots or jets of different cross-section or aperture size and/or distribution.

FIG. 3 is a schematic cross-section of a fuel injector 31 in accordance with the present invention. The injector 31 is located within a combustion chamber (not shown) in a similar fashion to injector 6 depicted in FIG. 1. The injector 31 includes a fuel injection portion 32 and air swirl arrangements 33, 34 arranged to ensure that air presented in the direction of arrowhead AA is swirled by the arrangements 33, 34 in order to create turbulent air in the direction AAA. The air flow in the direction AA as indicated previously is taken from a diffuser which in turn receives an air flow from a compressor through a conduit. As indicated previously with regard to FIG. 1 the air flow from the conduit is generally of a narrower cross-sectional width, illustrated by broken lines 35. Thus, there is a depleted zone (21 in FIG. 2) either side of a central direct impingement zone (23 in FIG. 2). In practice the pressure of the air flow within the region of direct impingement is of the order of several hundred psi with a variation in static pressure in the regions outside the direct impingement being of the order 1-2% of this value. For a fuel injector being fed with air at 600 psi the difference in pressure between the direct impingement region and the region outside this area is around 12 psi.

The fuel injection portion 32 simplistically comprises a conduit in which fuel flows in the direction of arrowheads F in order to create a fuel film upon a lip portion 36 of the fuel injector 31. The pressure of the fuel at the injector inlet is normally between 900 psi and 1500 psi, but this figure will vary depending on the engine and whether the engine is operating at full or partial power generation. The fuel film presented on the lip 36 which extends annularly as a collar is picked up by the turbulent air flow in the direction AAA created by the swirler arrangements 33, 34. Unfortunately, due to the depleted portions or zones as described previously fuel is concentrated in these depleted portions in comparison with the direct impingement portion of the air flow AAA. Such variations in fuel pick-up create similar variations in the fuel composition across the air flow in the direction AAA and subsequent combustion problems particularly with respect to emissions. As indicated previously ideally a uniform fuel mixture should be provided within the combustion chamber for best operational performance.

In accordance with the present invention a fuel distribution arrangement 37 is provided for use within a fuel injection nozzle. This fuel distribution arrangement 37 creates differential fuel flow at different points in the annular fuel flow conduit in the direction of arrowheads F so that more consistent relative fuel pick-up in the flow AAA is created. Generally, less fuel will be allowed through the arrangement 37 in the depleted portions of the air flow in comparison with the direct impingement portion of that flow in the direction AAA. In such circumstances the generally greater air volume passing through the direct impingement portion will receive more fuel whilst the lower volumetric air flow in the depleted portions will similarly receive less fuel. In such circumstances there is a balance between the air flow rate and the amount of fuel presented at the lip 36 in order to create a more uniform fuel/air mixture in the flow in the direction AAA. In short the arrangement 37 generally creates a differential zonal choke with regard to fuel presentation at the lip 36.

The fuel distribution arrangement is arranged along an arc that has a constant radius. As described later the differential flow at different points is achieved either by providing distribution structures which are closer together at regions of higher air flow pressure and further apart at regions of lower pressure, or distribution structures that are larger at regions of higher air flow pressure and smaller at regions of lower pressure or a combination of the two such that more fuel is presented to regions of higher air flow pressure than at the regions of lower pressure.

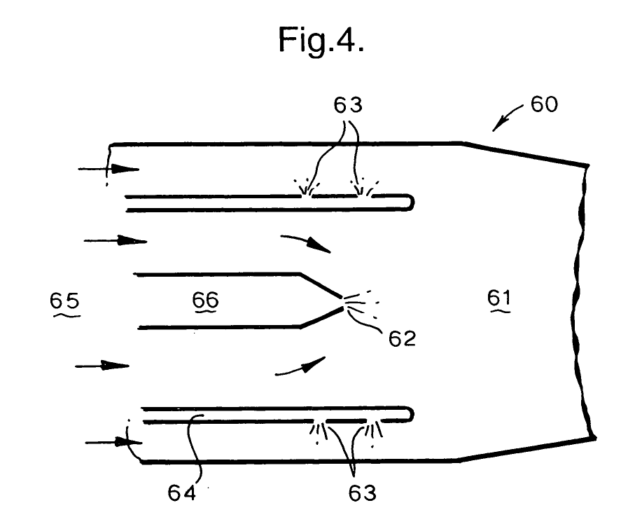

FIG. 4 is a schematic cross-section of a fuel combustion arrangement 60 in accordance with an alternative construction. The arrangement 60 includes a combustion chamber 61 which is presented with an air flow 65 in the direction of the depicted arrowheads. This air flow 65 is mixed with fuel presented through fuel injection apertures 62, 63 these apertures 62, 63 present a mixture of fuel to the air flow 65 and through appropriate swirling there is a mixing of the fuel with the air flow 65. As with the previous fuel distribution arrangement, the air flow 65 is typically taken from a compressor stage and diffuser of a turbine engine. Thus, the air flow 65 incorporates a direct impingement zone and depleted zones. If the apertures 63 are evenly distributed radially then there may be inappropriate fuel distribution for combustion within the combustion chamber 61. It will be understood the direct impingement zone will have a higher flow rate and pressure compared to the depleted zones and in such circumstances more fuel will generally be required in that direct impingement in comparison with the depleted zones in order to achieve the desired air/fuel mixture. The fuel passes along a conduit 64 and a passage 66 until projected through the apertures 62, 63 respectively. Typically, the conduit 64 and passage 66 will be coupled to a common fuel source.

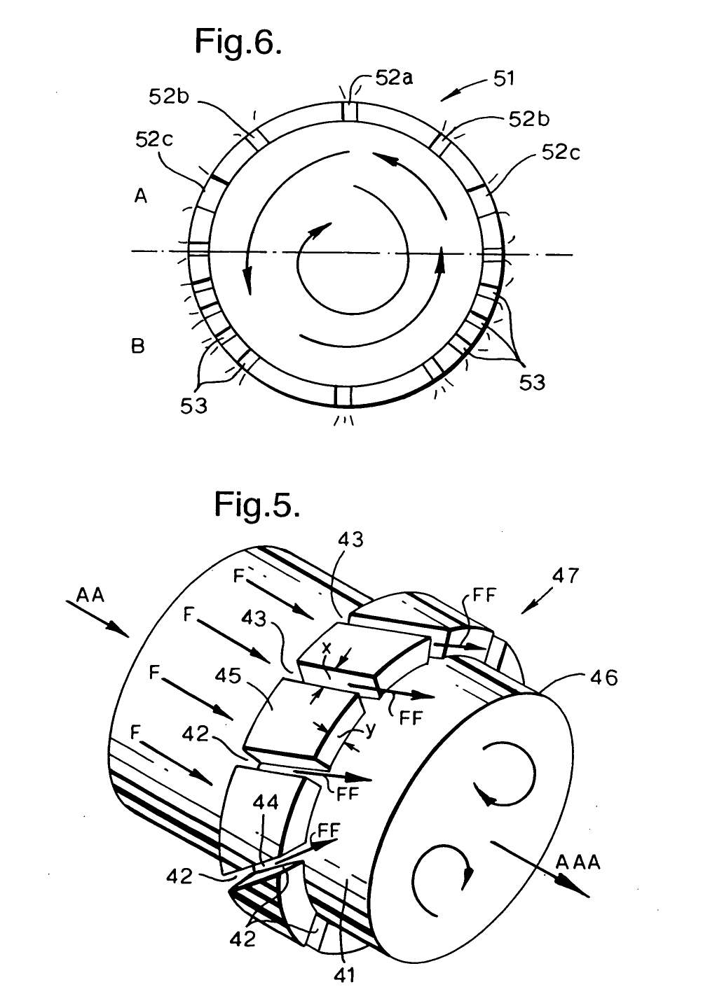

FIG. 5 illustrates one embodiment of a fuel distribution arrangement 47 for use within a fuel injection nozzle in accordance with the present invention. As previously, the arrangement 47 comprises a passage within which swirler vanes (not shown) are arranged to produce an air flow in the direction of the arrowheads AAA which is turbulent in order to pick up fuel from a lip 46. As indicated previously fuel passes through the arrangement in order to create a film upon a downstream surface 41 which flows towards the lip 46 in order to be entrained and picked up by the turbulent air flow created by the swirling arrangement of the injector nozzle. Normally, as illustrated with regard to FIG. 3 the conduit is formed by concentric sleeves such that a passage is created through which fuel flow in the direction of arrowheads F becomes incident upon the arrangement.

In accordance with the embodiment of the present invention depicted in FIG. 5 the fuel distribution arrangement comprises a number of channels or slots 42 which are generally angularly presented in order to swirl the fuel exiting the arrangement 47 in the direction of arrowheads FF. This swirling of the fuel towards the lip 46 facilitates further mixing with the turbulent air flow in the direction AAA and therefore more even distribution of the air/fuel mix. Specifically in accordance with the present invention the channels 42 at different points upon the circumference of the arrangement 47 have different widths x and/or heights y so that the relative fuel rate differs between different zones of the arrangement 47. In such circumstances, the rate at which fuel is presented to the depleted or lower pressure zones of the air flow in the direction AAA, created by the mismatch between the diffuser output air flow cross-section and the injector arrangement cross-section, can be adjusted in order to achieve a more uniform air/fuel mixture across the width of the flow AAA. As indicated previously more uniform air/fuel mixtures ensure more efficient combustion and better control of noxious emissions.

Typically the slots will have a substantially square or rectangular cross-section with an x dimension substantially equal to a y dimension. Possible values for x and y are as follows 0.25-1.00 mm. Alternatively, where desired or practicable in terms of manufacture the slots 42 may be particularly shaped by having a rounded bottom or otherwise. As indicated previously generally there will be an outer sleeve not shown in FIG. 4 which lies above the slots 42 in order that the slots comprise a closed passageway with an inlet side 43 and an outlet side 44. Alternatively, and again where practicable in terms of potential manufacture, lateral holes may be drilled in a band of material in order to create the slots 42 of different size or distribution in order to achieve the differential fuel flow across the fuel distribution structure of the arrangement.

Normally the slots 42 as illustrated in FIG. 4 are formed by machining a component in order to create islands or lands 45 which extend upward from the inner sleeve with slots 42 between them. Alternatively, it may be possible to provide a band of machined material which sits in a circumferential peripheral slot of the inner sleeve in order to create the slots 42. The band of material would simply be belted about the peripheral slot in order to present the slots 42.

As an alternative to use of channels 42 in order to differentially choke and therefore vary the fuel flow across a fuel distribution arrangement as depicted in FIG. 6 a jet collar 51 could be provided in which fuel either flows inward or outward in order to become mixed with a turbulent air flow created as described previously by air flow swirler vanes. In such circumstances, as illustrated in FIG. 6 there are two approaches with regard to achieving the necessary differential fuel presentation. In a first approach A, fuel jets 52 are provided of differing cross-section and therefore resistance to fuel flow. In such circumstances, fuel flow through jet 52a will be less than that through slightly wider jets 52b which in turn will be less than jets 52c. In such circumstances less fuel will be presented at the “twelve o'clock” position compared to the substantially three o'clock and nine o'clock positions. Alternatively, in arrangement B jets 53 of substantially the same cross-section are provided but with a distribution such that there is more fuel presented in the three o'clock and nine o'clock positions in comparison with the six o'clock position due to the presence of more jet 53 apertures at these locations. Clearly, the specific distribution or sizing of the jets 52, 53 will be such that an appropriate proportioning of fuel flow will be achieved for consistency with the differential between the depleted air flow portions (21 in FIG. 2) and the direct impingement zone (23 in FIG. 2). It will be understood that either approach A or B will normally be used throughout so that the twelve o'clock position will be repeated at six o'clock in approach A and vice versa in approach B.

Generally, due to engine combustion chamber orientation with regard to a diffuser annular channel it will be understood that with each fuel injector nozzle the depleted zones (21 in FIG. 2) will be at radially inner and outer positions (notional north/south or twelve o'clock and six o'clock positions). In such circumstances the channels 42 or jets 52, 53 will be similarly arranged to ensure that there is less fuel presented at these north/south or six o'clock and twelve o'clock positions to reflect the depletion in flow pressure between these portions (21 in FIG. 2) and the direct impingement portion (23 in FIG. 2).

Normally a notional air flow rate will be determined through the fuel injection nozzle. Typically, the divergence from this notional flow rate will be such that there is a plus 15% flow rate in the central direct impingement portion (23 in FIG. 2) relative to the notional average flow rate through the nozzle whilst there will be a minus 15% reduction in the depleted flow pressure in the depleted zones (21 in FIG. 2). To reflect this difference there will be a general 30% differential in the fuel flow rate between the depleted zones that is to say north/south or six o'clock and twelve o'clock positions and the more central three o'clock and nine o'clock or east/west portions of the fuel nozzle cross-section. Clearly, these values are simply exemplary and alternative values may be appropriate given different air flow rates and/or fuel type and/or other factors including temperature and performance requirements. Nevertheless, it will be understood that there is a gradual variation in transition between the depletion zones (21 in FIG. 2) and the central direct impingement zone (23 in FIG. 2) and this more gradual change will normally be reflected in a practical distribution of slots or injector distributions and/or widths.

As depicted in FIG. 3 generally the fuel distribution arrangement in accordance with the present invention is located near to the fuel pick-up or injection apertures into the turbulent air flow. Specific positioning will be determined by installation requirements. It will be understood that if the surface 41 (FIG. 5) between the slots 42 and the lip 46 were so long that there would be a general migration to even film distribution which would diminish the effectiveness of the present invention with regard to differential asymmetric fuel presentation to the turbulent air flow for more uniform air/fuel mixtures across the full width of the air flow. However, if the slots 42 were too close to the edge 46 the development of an appropriate film for dispersion about the lip 46 may not properly be achieved resulting in a coarser fuel droplet distribution in comparison with a desired fuel mist. Similarly, with injection apertures positioning is important to ensure the spray is allowed to develop to an appropriate mist for desired fuel distribution.

It will be understood that the air flow is swirled in a helix or cork-screw fashion so that the depletion zones similarly rotate as the flow progresses through the combustion chamber. Nevertheless, fuel pick-up in proportion to air volume is maintained to give a desired fuel distribution for combustion.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-15. (canceled)

16. A fuel injector arrangement for a gas turbine, the arrangement comprising an upstream diffuser and a downstream injector nozzle, the diffuser having a diverging passage for presenting a direct impingement air flow to the injector nozzle, the nozzle having a greater cross-section than the air flow directly impinging upon the nozzle in operation so that in operation the said nozzle has an air flow portion of higher pressure where there is direct impingement and air flow regions of lower pressure outside the portions of direct impingement, wherein the nozzle has a fuel distribution arrangement for presenting fuel to the air flow through the nozzle, the fuel being presented by fuel distribution structures in the nozzle, wherein the fuel distribution structures are at least one of asymmetrically distributed and sized to distribute in operation more fuel to said regions of higher pressure than to said regions of lower pressure.

17. A fuel injector arrangement according to claim 16, wherein the diverging passage is annular to present an annular air flow.

18. A fuel injector arrangement according to claim 17, wherein air flow impinges on the nozzle to provide a central flow portion of higher pressure and two regions of lower pressure flow portions the opposing edges of the central flow portion.

19. A fuel injector arrangement according to claim 16, wherein the fuel distribution structures are arranged in an annular array, wherein the spacing between structures varies such that there is a shorter spacing between structures in the region of higher pressure and a longer spacing between structures in the regions of lower pressure

20. A fuel injector arrangement according to claim 16, wherein the fuel distribution structures are arranged in an annular array, wherein the size of the structures varies such that there are larger structures in the region of higher pressure and a smaller structure in the regions of lower pressure.

21. A fuel injector arrangement according to claim 20, wherein the annular array lies along an arc which is at a uniform radius from an axis of the injector nozzle.

22. A fuel injector arrangement according to claim 19, wherein the fuel distribution structures are grooves.

23. A fuel injector arrangement as claimed in claim 19, wherein the fuel distribution structures comprises a number of passageways.

24. A fuel injector arrangement as claimed in claim 19, wherein the fuel distribution structures comprises a number of apertures.

25. A fuel injector arrangement as claimed in claim 16, wherein the fuel distribution structure is angled relative to the direction of air flow.

26. A gas turbine engine incorporating a fuel distribution arrangement as claimed in claim 16.

27. A gas turbine engine according to claim 26, wherein a plurality of downstream injector nozzles are provided, wherein the direct impingement air flow simultaneously impinges on each injector nozzle.
